(19) United States
(12) Patent Application Publication
(10) Pub. No.: US 2009/0034083 A1
(43) Pub. Date: Feb. 5, 2009

(54) Method of forming a microlens array and imaging device and system containing such a microlens array

(75) Inventors: Jin Li, Meridian, ID (US); Ulrich Boettiger, Boise, ID (US)

Correspondence Address: DICKSTEIN SHAPIRO LLP, 1825 EYE STREET NW, Washington, DC, 20006-5403, US

(73) Assignee: Micron Technology, Inc.

(21) Appl. No.: 11/882,065

(22) Filed: Jul. 30, 2007

(51) Int. Cl. G02B 27/12

(52) U.S. Cl. 359/619

(57) ABSTRACT

Method of forming a microlens array and an imaging device and system containing such a microlens array. The microlens array is formed with a plurality of substantially gapless microlenses. A plurality of overlying portions are formed on the microlenses and have substantially the same curvature and/or height.

### FIELD OF THE INVENTION

Embodiments described herein relate generally to a method of forming a microlens array and an imaging device and system containing such a microlens array.

### BACKGROUND OF THE INVENTION

Solid state imaging devices, also known as imagers, have been used in various photo-imaging applications, including cameras, camera mobile telephones, video telephones, computer input devices, scanners, machine vision systems, vehicle navigation systems, surveillance systems, auto focus systems, star trackers, motion detector systems, and image stabilization systems among other applications. There are a number of different types of semiconductor-based imaging devices, including charge coupled devices (CCDs), photodiode arrays, charge injection devices (CIDs), complementary metal oxide semiconductor (CMOS) imaging devices, and others. When used with appropriate imaging circuits, imaging devices can capture, process, store, and display images for various purposes.

Imaging devices are typically formed with an array of pixels each containing a photosensor, such as a photogate, phototransistor, photoconductor, or photodiode. The photosensor in each pixel detects incident radiation of a particular wavelength (e.g., optical photons or x-rays) and produces an electrical signal corresponding to the intensity of light impinging on that pixel when an optical image is focused on the pixel array. The electrical signals from all the pixels are then processed to provide information about the captured optical image for storage, printing, display, or other usage.

Microlenses have been used in various imaging devices to improve photosensitivity of the imaging devices by collecting incident light from a light collecting area and focusing the collected light onto a smaller photosensitive area of a photosensor. Microlenses may be formed through an additive process. In a conventional additive microlens fabrication, a lens material is deposited onto a substrate and formed into a microlens array using a reflow process. For example, the lens material is patterned into individual units with gaps around each unit. During reflow of the patterned lens material, a lens material is formed in a partially spherical shape driven by the force equilibrium of surface tension and gravity. The individual lens materials then harden in this shape to form microlenses.

Microlens shaping during fabrication can affect the focal characteristics of the resulting microlenses in the same microlens array. When microlenses in the same microlens array have different curvatures and/or heights, the microlenses can have different focal characteristics, which can compromise the quality of images captured by the imaging device.

It is desirable to provide an improved structure for a microlens array, imaging device, and/or system that reduces the effects of the above discussed deficiencies. It is also desirable to provide a method of fabricating a microlens array, imaging device, and/or system exhibiting these improvements.

### BRIEF DESCRIPTION OF THE DRAWINGS

FIG. 1A illustrates a partial cross-sectional view of an imaging device containing a microlens array formed in accordance with an embodiment disclosed herein.

FIG. 1B is a partial top-down view of the imaging device shown in FIG. 1A.

FIGS. 2A to 2D illustrate partial method steps for forming the microlens array of FIGS. 1A and 1B.

FIG. 2E is a perspective view of a microlens array formed according to another embodiment.

FIGS. 3A to 3D illustrate additional method steps for forming the microlens array shown in FIGS. 1A and 1B.

FIG. 4 is a flow chart illustrating a method of fabricating the imaging device containing a microlens array formed in accordance with the embodiment disclosed herein.

FIG. 5 is a block diagram of an imaging device constructed in accordance with one of the embodiments disclosed herein.

FIG. 6 is an illustration of an imaging system comprising the imaging device formed in accordance with one of the embodiments disclosed herein.

### DETAILED DESCRIPTION OF THE INVENTION

In the following detailed description, reference is made to the accompanying drawings, which form a part hereof and show by way of illustration specific embodiments and examples in which the claimed invention may be practiced. These embodiments and examples are described in sufficient detail to enable one skilled in the art to practice them. It is to be understood that other embodiments and examples may be utilized, and that structural, logical, and electrical changes and variations may be made. Moreover, the progression of processing steps is described as an example; the sequence of steps is not limited to that set forth herein and may be changed, with the exception of steps necessarily occurring in a certain order.

The term “substrate” used herein may be any supporting structure including, but not limited to, a semiconductor substrate having a surface on which devices can be fabricated. A semiconductor substrate should be understood to include silicon, silicon-on-insulator (SOI), silicon-on-sapphire (SOS), doped and undoped semiconductors, epitaxial layers of silicon supported by a base semiconductor foundation, and other semiconductor structures, including those made of semiconductors other than silicon. When reference is made to a semiconductor substrate in the following description, previous process steps may have been utilized to form regions or junctions in or over the base semiconductor or foundation.

The term “pixel” or “pixel cell” as used herein, refers to a photo-element unit cell containing a photosensor for converting photons to an electrical signal as may be employed by an imaging device. The pixel cells described herein in the embodiments can be CMOS four-transistor (4-T) pixel cells, or pixel cells that have more or less than four transistors. In addition, the embodiments disclosed herein may be employed in other types of solid state imaging devices other than CMOS imaging devices, e.g., CCD and others, where a different pixel and readout architecture may be used.

The term “substantially gapless” is intended to cover not only microlens arrays having zero gaps between adjacent microlenses, but is also intended to more broadly encompass microlens arrays having substantially no gapping in areas between the microlenses. For example, a microlens array having approximately 3% or less of its surface area being space not covered by a microlens (i.e., approximately 3% or less gaps), is considered substantially gapless.

The term “microlens” as used herein refers to a transparent structure that condenses paths of wavelengths of light from a generally larger field to a generally smaller field focused on a photosensor.

Various embodiments are now described with reference to the drawing figures, in which similar components and elements are designated with the same reference numeral and redundant description is omitted. Although the embodiments are described in relation to use with a CMOS imaging device, as noted, the embodiments are not so limited and have applicability to other solid state imaging devices.

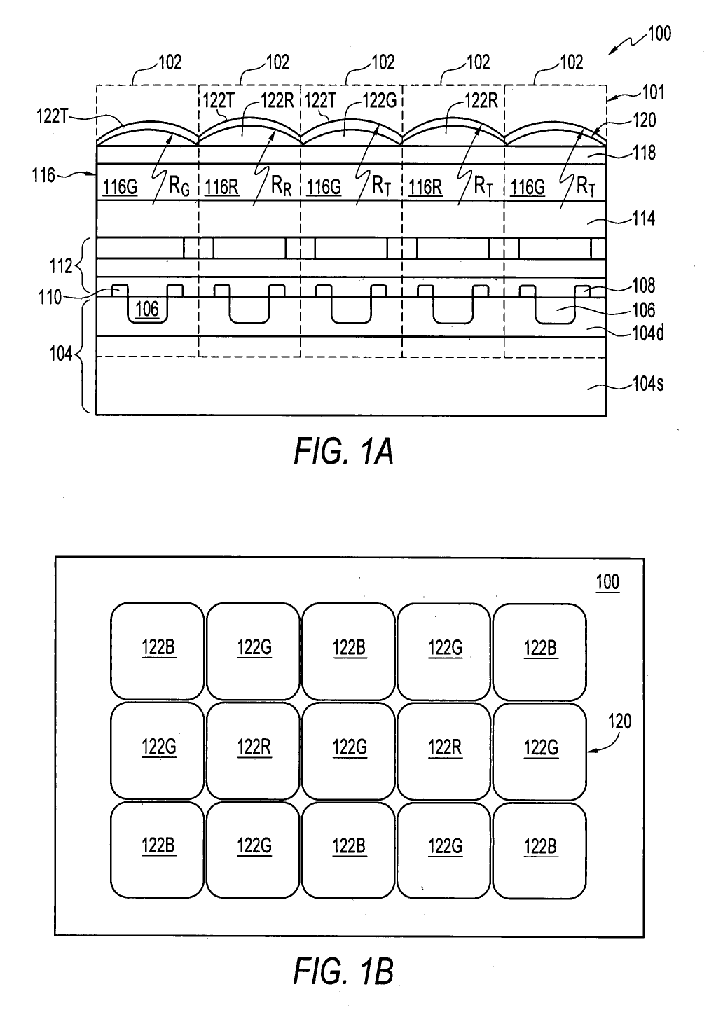

FIG. 1A illustrates a partial cross-sectional view of a portion of a semiconductor-based imaging device 100, such as a CMOS imaging device, constructed in accordance with one embodiment. The imaging device 100 can comprise an image pixel array 101 comprising a plurality of image pixel cells 102 and circuitry layers.

Each pixel cell 102 can be formed over a semiconductor device substrate 104. The device substrate 104 can have a single layer structure, such as an active silicon layer or a combination of several layers with different implantation conductivities and concentrations. For example, in a p-type semiconductor device, the device substrate 104 can be formed to include a silicon layer 104s and one or more p-doped layers 104d formed along with the silicon layer 104s. Those skilled in the art will appreciate that the device substrate 104 can be in various other forms and can be formed by various methods.

A photosensor 106 can be formed in each pixel cell 102 in association with the device substrate 104. Any of various photosensors 106, such as a photogate, phototransistor, photoconductor, or photodiode, can be employed. For a color imaging device, each photosensor 106 can be formed to receive one of red, green, and blue light passing through an appropriate color filter. For a monochromatic imaging device, all photosensors 106 of a pixel array 101 can receive the same incident wavelengths, through no filter or the same type of filters. For example, all photosensors 106 are formed to detect infrared light. Those skilled in the art will appreciate that the photosensor 106 can be in various other forms.

The imaging device 100 can comprise other semiconductor structures and components that may be conventionally employed and formed in association with the substrate 104. For example, a plurality of transistors 108, 110, such as those used in a 4-T CMOS image pixel, can be provided in each pixel cell 102. A plurality of interlayer dielectrics, collectively shown as 112, can be provided for the image pixel array 101. A passivation layer 114 is formed over the interlayer dielectrics 112, and is typically planarized, such as by chemical mechanical polishing (CMP), to create a substantially flat surface. The passivation layer 114 can be formed, for example, of one or more of phospho-silicate-glass (PSG), silicon nitride, nitride, oxide, and oxynitride. Those skilled in the art will appreciate that the transistors 108, 110, interlayer dielectrics 112, and passivation layer 114 can be in various other forms and be formed by various methods.

Optionally, a color filter array 116 can be provided over the passivation layer 114. The color filter array 116 can comprise color filters 116R, 116G, each corresponding to a photosensor 106. For example, the color filter array 116 can include first and second color filters 116R, 116G and additional color filters in adjacent rows. For a color imaging device, the first and second color filters 116R, 116G and additional color filters in adjacent rows, are each adapted to pass a selected radiation component in the incident light. The illustrated color filters 116R, 116G are red and green filters, respectively. The red and green filters 116R, 116G and additional red filters in adjacent rows can be arranged in any of various patterns, such as e.g., a Bayer pattern. For a monochromatic imaging device, the color filters 116R, 116G and additional filters can be similarly formed to pass the same color of light, or otherwise be left out of the imaging device 100. In the example shown in FIG. 1A, a planarized layer 118 is provided on the color filter array 116 to assist in planarizing the various color filters 116R, 116G.

The imaging device 100 includes a microlens array 120 (see FIG. 11B) formed over the passivation layer 114. When a color filter array 116 is employed in the imaging device 100, the microlens array 120 can be formed over the color filter array 116, or the planarized layer 118. The microlens array 120 contains a plurality of microlenses 122R, 122G, 122B arranged in rows and columns, as is shown FIG. 11B. For example, the microlens array 120 can include first and second microlenses 122R, 122G in one row of the microlens array 120, and additional microlenses, such as 122G, 122B, in adjacent rows. Although the microlens array 120 in FIG. 11B is shown to contain fifteen microlenses 122R, 122G, 122B, a microlens array 120 could contain millions of microlenses formed over millions of pixel cells 102 depending upon the size and resolution of the imaging device 100.

The microlens array 120 can be formed for use in a monochromatic imaging device and/or a color imaging device. For a monochromatic imaging device 100, the various microlenses 122R, 122G, 122B can be similarly formed, such as of the same lens material. For a color imaging device 100, the microlenses 122R, 122G, 122B can each correspond to a first, second, and third color (e.g., red, green, and blue). For example, the first, second, and additional microlenses 122R, 122G, 122B can be formed to correspond to respectively the first, second, and additional color filters 116R, 116G, so that the imaging device 100 can be used to detect a color image. In one example as shown in FIG. 1A, first and second microlenses 122R, 122G can be formed over respective red and green color filters 116R, 116G. The first, second, and additional microlenses 122R, 122G, 122B can be arranged in any of various patterns, such as a Bayer pattern shown in FIG. 1B.

The microlenses 122R, 122G, 122B can each be formed in a pixel cell 102 and in association with a photosensor 106 provided in the same pixel cell 102. Each microlens 122R, 122G, 122B can be formed to cover substantially the entire pixel cell 102. In one example, the microlens array 120 can be formed so that adjacent microlenses 122R, 122G, 122B are in contact with one another. For example, adjacent microlenses 122R, 122G can be formed to partially overlap each other, as is shown in FIG. 1A, or otherwise abut each other, e.g., the edge of first microlens 122R partially abuts an edge of an adjacent second microlenses 122G. Additionally or alternatively, the microlens array 120 formed can contain a gap between adjacent microlenses 122R, 122G, 122B, as is shown in FIG. 1B. By forming microlenses 122R, 122G, 122B close to one another, e.g., overlapping or abutting microlenses 122R, 122G, 122B, the resulting microlens array 120 is substantially gapless or otherwise has reduced or no empty space between adjacent microlenses 122R, 122G, 122B, thereby increasing quantum efficiency of the pixel array 101.

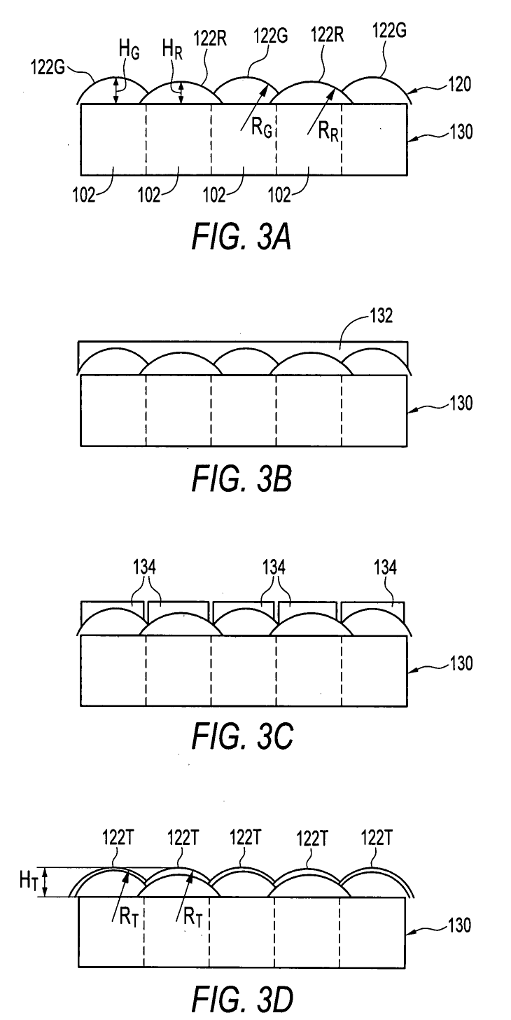

The microlenses 122R, 122G, 122B can be formed to have any of various configurations, such as spherical, aspherical, and substantially planar shapes with rounded edges. For example, the microlenses 122R, 122G, 122B can each have a curved shape in a cross-sectional view shown in FIG. 1A and substantially square shape in a top-down view shown in FIG. 11B. In the example shown in FIG. 1A, the first and second microlenses 122R, 122G can have a spherical shape with radii R_{R}, R_{G}, respectively (see also FIG. 3A). The radii R_{R}, R_{G} can be the same or different from each other depending on various factors, such as the type of process and the conditions of the process for forming the first and second microlenses 122R, 122G. As one skilled in the art will appreciate, the first and second microlenses 122R, 122G can also be formed to have a shape other than a spherical shape.

Additionally or alternatively, the first and second microlenses 122R, 122G can have the same or different heights H_{R}, H_{G} (see FIG. 3A), depending on various factors, such as the type of process and the conditions of the process for forming the first and second microlenses 122R, 122G. In one example, each additional microlens 122B can be formed to have the same or different curvature and/or height from that of at least one of the first and second microlens 122R, 122G. Any of various methods can be used to form the microlenses 122R, 122G, 122B as will be described in great detail below.

Microlenses 122R, 122G, 122B can be formed of any of various lens materials. For example, the microlenses 122R, 122G, 122B can be any transparent material, such as glass, that allows incident light to pass through. Exemplary lens materials include, but are not limited to, glass, for example, zinc selenide (ZnSe), boro-phospho-silicate glass (BPSG), phosphosilicate glass (PSG), borosilicate glass (BSG), silicon oxide, silicon nitride, or silicon oxynitride; an optical thermoplastic material such as tantalum pentoxide (Ta₂O₅), titanium oxide (TiO₂), polymethylmethacrylate, polycarbonate, polyolefin, cellulose acetate butyrate, or polystyrene; a polyimide; a thermoset resin such as an epoxy resin; a photosensitive gelatin; or a radiation curable resin such as acrylate, methacrylate, urethane acrylate, epoxy acrylate, or polyester acrylate.

As FIG. 1A also shows, a plurality of overlying portions 122T are formed over and conforming to the microlenses 122R, 122G, by any of various methods described below. Each overlying portion 122T can substantially entirely cover the upper surface of the underlying microlens 122R, 122G, as well as additional microlens 122B (see FIG. 1B). In one example, the overlying portions 122T are integrated with one another.

The various overlying portions 122T can be formed to be uniform to one another across the microlens array 120. For example, the overlying portions 122T can be formed to have a convex upper surface with a substantially uniform curvature throughout the microlens array 120. In one example, the upper surfaces of the overlying portions 122T can be spherical and have substantially the same radius R_{T}. Additionally or alternatively, the overlying portions 122T can have positional uniformity across the microlens array 120. For example, the overlying portions 122T can have substantially the same heights H_{T} (see, FIG. 3D), such as measured from the top surface of the semiconductor structure 130. In another example, the overlying portions 122T are evenly distributed across the microlens array 120.

The overlying portions 122T can be formed of any of various materials, such as any of those used to form the microlenses 122R, 122G, 122B. In one example, the overlying portions 122T are made of the same material used for at least one of the microlenses 122R, 122G, 122B. For example, the overlying portions 122T are formed of a reflowable material, which allows incident light to pass through. Any of various methods can be used to form the overlying portions 122T as will be described in great detail below.

Because the overlying portions 122T can be formed to have substantially the same curvature (e.g., height H_{T} and/or radius R_{T}) and/or same material throughout the microlens array 120, the overlying portions 122T can correct or compensate for the differences among the various microlenses 122R, 122G. For example, the overlying portions 122T can correct or compensate for the different radii R_{R}, R_{G} of the underlying microlenses 122R, 122G and provide a substantially uniform curvature throughout the microlens array 120. Additionally or alternatively, the overlying portions 122T can be formed to have a different radius R_{T} from the radii R_{R}, R_{G} of the underlying microlenses 122R, 122G. In one example, the overlying portions 122T can have a smaller radius R_{T} than the radii R_{R}, R_{G} of the underlying microlenses 122R, 122G so that the resulting microlens array 120 can further focus incident light impinged on the microlens array 120.

The overlying portions 122T can also provide a planarized microlens array 120 causing the combined microlenses 122R, 122G, 122B and overlying portions 122T to have substantially the same heights H_{T} across the microlens array 120, regardless of the heights H_{R}, H_{G} of the underlying microlenses 122R, 122G, 122B. As FIG. 3A shows, microlenses 122R, 122G can have different heights H_{R}, H_{G}, which can be caused from the separate method steps used during the formation of such microlenses 122R, 122G. The resulting microlens array 120 can have a more balanced structure and afford more uniform optical characteristics among the various pixel cells 102 throughout the microlens array 120.

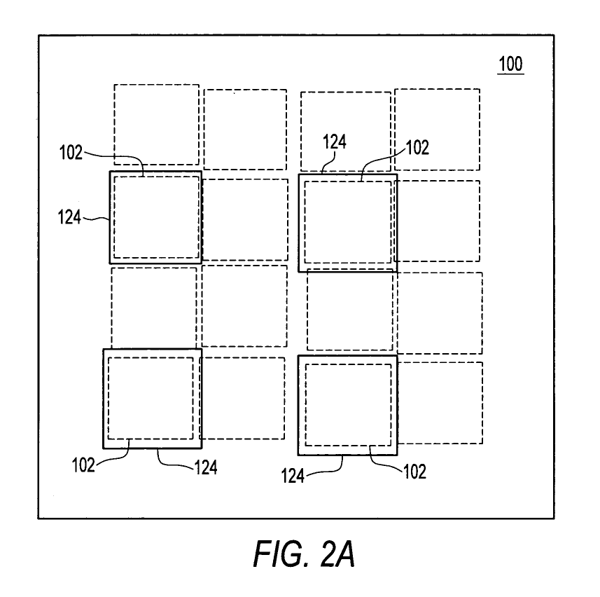

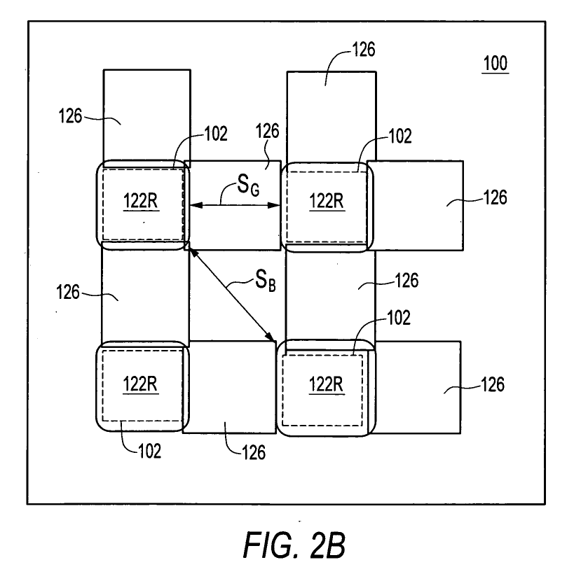

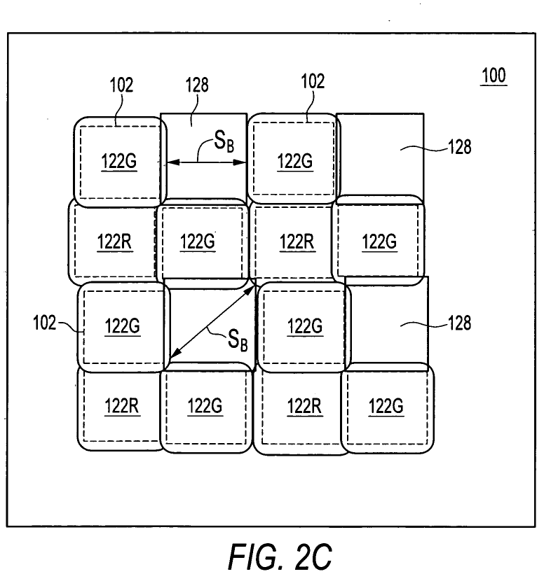

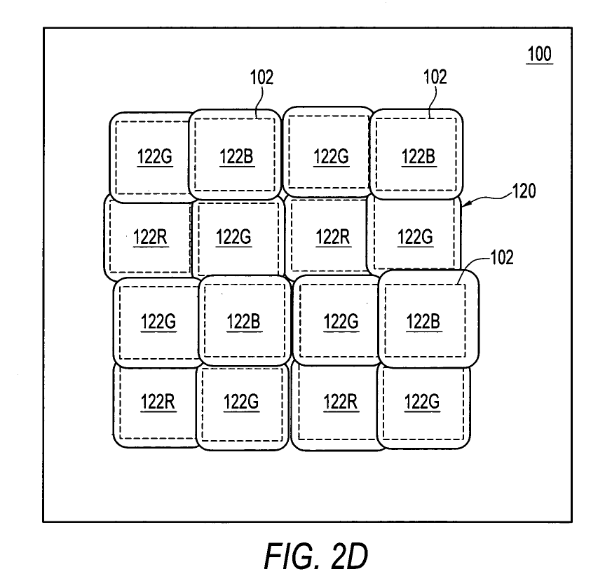

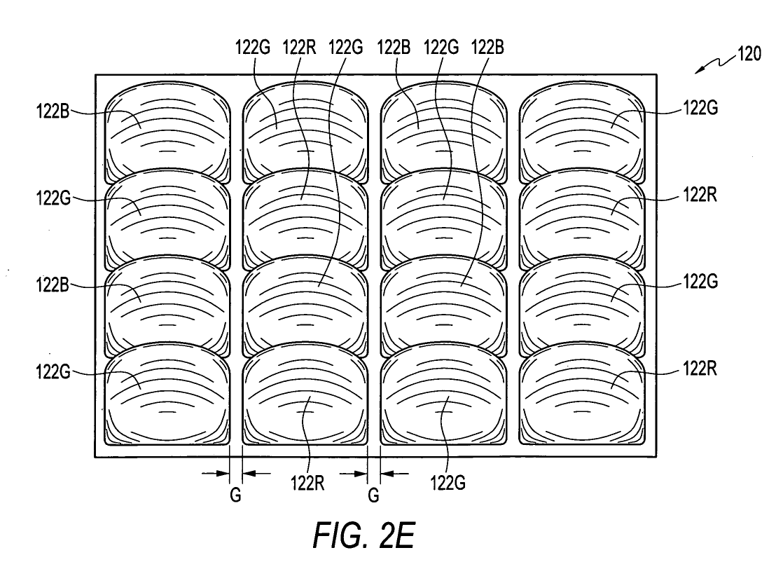

Fabrication of the microlens array 120 is now described in connection with FIGS. 2A to 2D and FIGS. 3A to 3D. FIGS. 2A to 2D are top-down views, whereas FIGS. 3A to 3D are partial cross-sectional views of the microlens array 120 in the progress of making.

As illustrated in FIG. 2A, first microlens precursors 124 are selectively deposited and patterned over an array of pixel cells 102. For example, a precursor material can be deposited over the color filter array 120 and patterned over color filters 116R (FIG. 1A), which correspond to respectively first color (e.g., red). The first microlens precursors 124 can be formed from any of various materials, such as any of the lens materials discussed above. In one example, the first microlens precursors 124 can be formed from a material that can melt and flow into a solidly, cross-linked polymer upon a reflow process. In addition, the first microlens precursors 124 can be formed from a material that is impervious to subsequent reflow processes.

The patterning of the first microlens precursors 124 can be a checkerboard pattern, which includes spaces between portions of the first microlens precursor 124 (FIG. 2B). The first microlens precursors 124 should be aligned with the photosensor 106 (FIG. 1A) in the pixel cell 102 as required depending on the angle of incident light. Although each first microlens precursor 124 is illustrated as having a substantially rectangular configuration and each is shown being substantially equal in size with the others, it is not intended to be limiting in any way. For example, each of the first microlens precursors 124 can be formed to have other shapes and be substantially different in size from one another.

In a process step as illustrated in FIG. 2B, a plurality of first microlenses 122R are formed, such as for a first color (e.g., red), from the first microlens precursors 124, such as by a reflow process. During a reflow process conducted under reflow conditions, the substantially rectangular configuration of each first microlens precursor 124 is transformed into the first microlens 122R, which has a somewhat rectangular configuration with rounded edges and a curved top. As is shown in FIG. 2B, there are spaces SG, SB left between the plurality of first microlenses 122R. The first microlenses 122R will retain their shape even if a subsequent reflow process is performed to form the second and additional microlenses 122G, 122B.

After forming the first microlenses 122R, a plurality of second microlens precursors 126 are selectively deposited at predetermined positions, such as in some of the spaces (e.g., spaces SG) between the first microlenses 122R. For example, the second microlens precursors 126 are placed adjacent the first microlenses 122R. In one example shown in FIG. 2B, the second microlens precursors 126 can be patterned in a substantially rectangular configuration.

FIG. 2C shows that a plurality of second microlenses 122G, such as for a second color (e.g., green), can be formed from the second microlens precursors 126, such as by a second reflow process. It should be noted that the second reflow process may be conducted under different conditions than the first reflow process, if desired. As is illustrated in FIG. 2C, portions of the second microlenses 122G can be formed overlapping adjacent first microlenses 122R, as discussed above with respect to FIGS. 1A and 1B, so that such overlapping first and second microlenses 122R, 122G are substantially gapless in between.

There remains additional spaces SB where third microlens precursors 128 can be selectively deposited and patterned, as is illustrated in FIG. 2C. The third microlens precursors 128 can be patterned in a substantially rectangular configuration, and positioned in the remaining spaces SB left between the first and second microlenses 122R, 122G.

The third microlens precursors 128 can be reflowed to form the additional microlenses 122B, such as for a third color (e.g., blue) as illustrated in FIG. 2D. In one example, portions of the additional microlenses 122B can be formed to overlap the adjacent first and second microlenses 122R, 122G to result in a substantially gapless microlens array 120, as discussed above with respect to FIGS. 1A and 1B.

The above process steps are one example of forming a microlens array 120, in which the microlenses 122R, 122G, 122B can substantially overlap one another resulting in a substantially gapless microlens array 120. Although not shown, the microlenses 122R, 122G, 122B can be formed to abut one another to result in a substantially gapless microlens array 120. Additionally or alternatively, the microlens array 120 can be formed in other forms, such as e.g., containing a gap between adjacent microlenses 122R, 122G, 122B.

As one skilled in the art will appreciate, the order of forming the first, second, and additional microlenses 122R, 122G, 122B can also be altered and is not limited by the above described embodiment. For example, although all of the second microlenses 122G are illustrated as being formed simultaneously, it is not intended to be limiting in any way. In one example, the second microlenses 122G positioned between the first microlenses 122R can be formed prior to forming those second microlenses 122G between two additional microlenses 122B. As one skilled in the art will appreciate, various other methods or techniques can be employed to form a microlens array 120 in a gapless manner or otherwise.

In a resultant microlens array 120 (also see FIG. 1A), the microlens 122R, 122G, 122B can each have a focal point directed to a corresponding photosensor 106. The position, volume, material, and/or dimensions of each microlens 122R, 122G, 122B can be adapted to ensure that photo radiation is directed to the corresponding photosensor 106 in the same pixel cell 102. The various microlenses 122R, 122G, 122B formed may or may not have the same focal length throughout the microlens array 120. For example, when microlenses 122R, 122G, 122B are formed in separate process steps, the resulting microlenses 122R, 122G, 122B may have different focal lengths and/or slightly different relative positions to the photosensors 106.

FIG. 2E shows a microlens array 120 formed according to another embodiment, in which various microlenses 122R, 122G, 122B are formed simultaneously. For example, instead of selectively patterning a precursor material to form first microlens precursors 124 as shown in FIG. 2A, the microlens precursors can be patterned over all pixel cells 102 and shaped into microlenses 122R, 122G, 122B. For example, a reflow process can be carried out to transform the microlens precursors into the pin cushion shaped microlenses 122R, 122G, 122B shown in FIG. 2E. The various microlenses 122R, 122G, 122B formed can have substantially the same curvature and/or height. As FIG. 2E illustrates, adjacent microlenses 122R, 122G, 122B may be spaced from each other by a gap G. As one skilled in the art will appreciate, other methods and techniques can be used to form microlens arrays 120 and microlenses 122R, 122G, 122B of other configurations.

FIGS. 3A to 3D illustrate additional process steps for forming a plurality of overlying portions 122T on the microlenses 122R, 122G, 122B (see FIG. 2D).

FIG. 3A shows one row of a pixel array in the process of being made, such as e.g., subsequent to the process steps described above in connection with FIGS. 2A to 2D. The first and second microlenses 122R, 122G, and additional microlenses 122B (see FIG. 2D), are formed over a generally designated semiconductor structure 130, which can include one or more of the device substrate 104, interlayer dielectrics 112, passivation layer 114, color filter array 116, and planarized layer 118 described above. The first, second, and additional microlenses 122R, 122G, 122B, when formed separately, may have shape variations (e.g., different curvatures, such as different radii R_{R}, R_{G}) and/or position variations (e.g., varied heights H_{R}, H_{G} or uneven distribution across the microlens array 120). Such microlenses 122R, 122G, 122B can have varied focal characteristics, which may compromise the quality of images captured by the imaging device 100.

In the process step shown in FIG. 3B, a precursor material 132 is formed over the first and second microlenses 122R, 122G, as well as additional microlenses (not shown) in adjacent rows to the microlenses 122R, 122G, by any of various methods, such as spin or spray coating. In one example, the precursor material 132 can be formed over the entire microlens array 120 (FIG. 3A). The precursor material 132 can be deposited directly on top of the microlenses 122R, 122G and conform to their curved lens shape(s). As stated above, the precursor material 132 can comprise a precursor material similar to that forming one of the microlenses 122R, 122G. As one example, the precursor material layer 132 is formed of a transparent material, such as a glass material, that allows wavelengths of light to pass through.

FIG. 3C shows that the precursor material 132 is patterned to form a plurality of microlens precursors 134 overlying one or more of the microlenses 122R, 122G, and additional microlenses (not shown). In one example, the microlens precursors 134 are formed on all of the microlenses. Any of various patterning techniques can be used to form the individual microlens precursors 134. For example, a lithography step, optionally followed by an etching process, can be used to selectively remove portions of the precursor material layer 132 to result in individual microlens precursors 134. The microlens precursors 134 can have any of various shapes including a substantially rectangular configuration in a top-down view of the microlens precursors 134.

In the process step shown in FIG. 3D, a plurality of overlying portions 122T are formed from the microlens precursors 134. For example, a reflow process can be conducted, under reflow conditions, to transform the substantially rectangular configuration of the microlens precursors 134 into the overlying portions 122T. The overlying portions 122T can have a somewhat rectangular configuration with rounded edges and a curved top. The reflow conditions can be determined so that the first and second microlenses 122R, 122G, and additional microlenses 122B (see, e.g., FIG. 1B), will retain their shape(s) during the reflow process.

As FIG. 3D shows, the overlying portions 122T formed can have a uniform curvature. Additionally or alternatively, the overlying portions 122T can have the same height H_{T}, such as measured from the top surface of the semiconductor structure 130, regardless whether the underlying microlenses 122R, 122G, 122B have the same or different heights.

An example of reflow conditions is described next. The shape and/or size of the microlenses 122R, 122G, 122B, as well as the overlying portions 122T after being subjected to reflow conditions, can be defined by several factors, including the thickness and type of material used to form the microlenses 122R, 122G, 122B, and the overlying portions 122T, the reflow temperature profile, and any pretreatment of the material that changes its glass transition temperature T_{g}. Examples of pretreatments that affect reflow include ultraviolet light exposure or preheating the material to a temperature below the glass transition temperature T_{g}.

An example of reflow conditions for first microlenses 122R may include providing a plurality of first microlens precursors 124 (FIG. 2A) formed of a first type of material to have a first thickness, exposing the first microlens precursors 124 with an ultraviolet light flood exposure, and reflowing at a first temperature ramp rate, followed by a curing process step. Reflow conditions for second microlenses 122G may include providing second microlens precursors 126 of a second type of material at a second thickness and reflowing the second microlens precursors 126 with the first temperature ramp rate, followed by a curing process step. Reflow conditions for additional microlenses 122B may include providing additional microlens precursors 128 (see FIG. 2C) of a third type of material and of a third thickness, pre-heating the material to a temperature below the transition glass temperature T_{g} of the additional microlens precursors 128 for a set period of time, and then reflowing with a second temperature ramp profile, followed by a curing process.

Reflow conditions for the overlying portions 122T may include providing fourth individual microlens precursors 134 of a fourth type of material and of a fourth thickness, pre-heating the material to a temperature below the transition glass temperature T_{g} of the fourth microlens precursors 134 for a set period of time, and then reflowing at a third temperature ramp rate, followed by a curing process step.

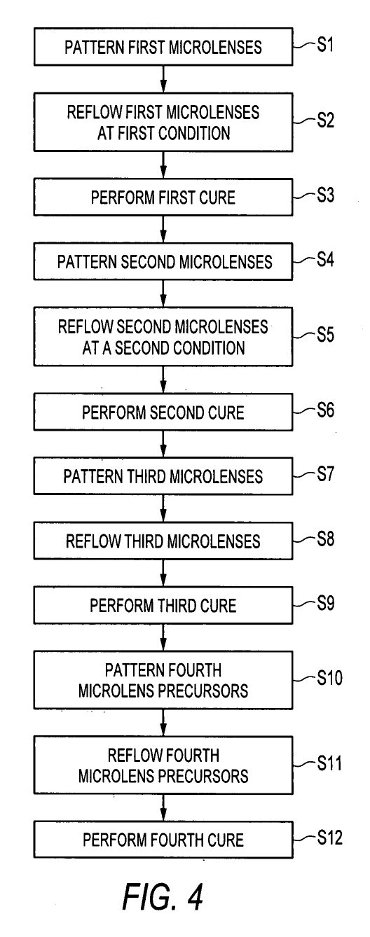

FIG. 4 illustrates a flow chart describing an example of a process for forming the microlens array 120. At step S1, the first microlens precursors 124 are patterned and formed onto, e.g., the color filter array 116 (FIG. 2A). The patterning of the first microlens precursors 124 can be a checkerboard pattern, as described above. A single reticle may be used to prepare each of the first microlens precursor 124 patterns. In the patterning step, a thin film of microlens material of a first thickness is coated on the substrate. The material is exposed using a suitable mask, and developed to either dissolve the exposed microlens material (positive resist) or dissolve the unexposed microlens material (negative resist) to obtain the first microlens precursors 124 (FIG. 2A). At step S2, the first microlens precursors 124 are reflowed, turning the first microlens precursors 124 into the first microlenses 122R (FIG. 2B). At step S3, the first microlenses 122R are cured, thus forming a checkerboard pattern of solidly, cross-linked first microlenses 122R.

At step S4, the second microlens precursors 126 (FIG. 2B) are patterned, e.g., onto the color filter array 116 in some of the spaces between the first microlenses 122R. Similarly, a single reticle may be used to prepare each of the second microlens precursors depositions. If the second microlens precursors 126 are of the same size as the first microlens precursor 124, the same reticle used for the first microlens precursor 124 may be used for patterning the second microlens precursors 126. To create the pattern of the second microlens precursors 126, the reticle is shifted.

At step S5, the second microlens precursors 126 may be reflowed to form the second microlenses 122G (e.g., FIG. 2C). The reflow conditions for the second microlens precursors 126 may be different or the same as the reflow conditions for the first microlens precursors 124, depending on the application. For example, the reflow conditions for the second microlens precursors 126 could entail varying the exposure and/or the dose of bleaching or the baking step temperature. By using different reflow conditions, the first microlenses 122R and second microlenses 122G can be formed having the same or different focal lengths. At step S6, a second cure process is performed.

At step S7, additional microlens precursors 128 (FIG. 2C) are patterned in the open spaces remaining between the first and second microlenses 122R, 122G. At step S8, the additional microlens precursors 128 may be reflowed at a reflow condition to form the additional microlenses 122B (e.g., FIG. 2D). The reflow conditions used to form the additional microlenses 122B may be different or the same as the conditions used to form the first and second microlenses 122R, 122G, for example, by varying the doses of exposing and/or bleaching or the baking step temperature. By using different reflow conditions, the additional microlenses 122B (see, e.g., FIG. 11B) can be formed such that their focal lengths are the same as or different from the focal lengths of the first and second microlenses 122R, 122G (e.g., FIG. 2D). At step S9, a third cure process step is performed.

The advantages of forming the first, second, and additional microlenses 122R, 122G, 122B in separate steps include the potential to tailor each microlens to the specific color the microlenses are intended to transmit, to better align the first, second, and additional microlenses 122R, 122G, 122B with the photosensors 106 of the shared pixel cell array 101, and to facilitate obtaining a substantially gapless microlens array 120.

At step S10, fourth microlens precursors 134 (FIG. 3C) are patterned over the entire microlens array 120 and covering the first, second, and additional microlenses 122R, 122G, 122B. At step S11, the fourth microlens precursors 134 may be reflowed at a reflow condition to form the overlying portions 122T of the microlenses 122R, 122G, 122B. The reflow conditions used to form the overlying portions 122T may be the same as or different from the conditions used to form the first, second, and additional microlenses 122R, 122G, 122B, for example, by varying the doses of exposing and/or bleaching or the baking step temperature. For example, by varying the reflow conditions of the microlens precursors 134, the curvature and/or height of the resulting overlying portions 122T can vary, such as to obtain the desired focal length or focal point. At step S12, a fourth cure process step is performed to harden the overlying portions 122T.

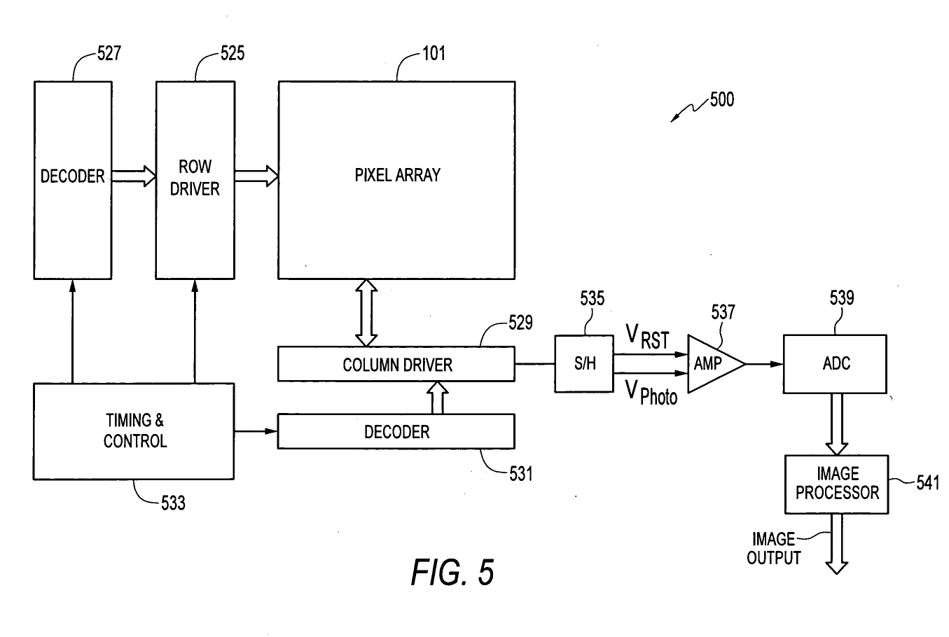

FIG. 5 is a block diagram showing the major electrical components of a CMOS imaging device 500, which contains a pixel array 101 having a microlens array 100 constructed as described above. The pixel array 101 is formed with pixel cells arranged in a predetermined number of columns and rows. The pixel array 101 can capture incident radiation from an optical image and convert the captured radiation to electrical signals, such as analog signals.

The electrical signals obtained and generated by the pixel cells in the pixel array 101 can be read out row by row to provide image data of the captured optical image. For example, pixel cells in a row of the pixel array 101 are all selected for read-out at the same time by a row select line, and each pixel cell in a selected column of the row provides a signal representative of received light to a column output line. That is, each column also has a select line, and the pixel cells of each column are selectively read out onto output lines in response to the column select lines. The row select lines in the pixel array 101 are selectively activated by a row driver 525 in response to a row address decoder 527. The column select lines are selectively activated by a column driver 529 in response to a column address decoder 531.

The imaging device 500 can also comprise a timing and controlling circuit 533, which generates one or more read-out control signals to control the operation of the various components in the imaging device 500. For example, the timing and controlling circuit 533 can control the address decoders 527 and 531 in any of various conventional ways to select the appropriate row and column lines for pixel signal read-out.

The electrical signals output from the pixels on the column output lines typically include a pixel reset signal (V_{RST}) and a pixel image signal (V_{Photo}) for each image pixel cell in a CMOS imaging device. In an example of an image pixel array 101 containing four-transistor CMOS image pixel cell, the pixel reset signal (V_{RST}) can be obtained from a floating diffusion region when it is reset by a reset signal RST applied to a corresponding reset transistor, while the pixel image signal (V_{Photo}) is obtained from the floating diffusion region when photo generated charge is transferred to the floating diffusion region. Both the V_{RST} and V_{Photo} signals can be read into a sample and hold circuit (S/H) 535. In one example, a differential signal (V_{RST}-V_{Photo}) can be produced by a differential amplifier (AMP) 537 for each pixel cell. Each pixel cell's differential signal can optionally be amplified and is then digitized by an analog-to-digital converter (ADC) 539, which supplies digitized pixel data as the image data to an image processor 541, which processes the pixel signals from the pixel array 101 to produce an image. Those skilled in the art would appreciate that the imaging device 500 and its various components can be in various other forms and/or operate in various other ways. In addition, although the imaging device 500 illustrated is a CMOS imaging device, other types of solid state imaging devices, pixel arrays, and readout circuitries may also be used.

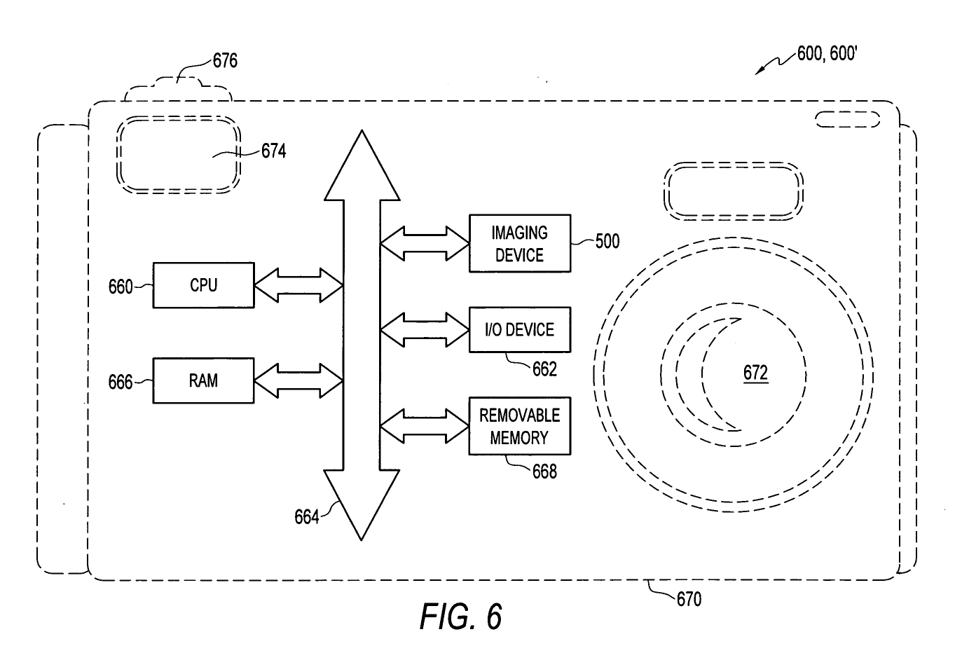

FIG. 6 illustrates a processing system 600 including an imaging device 500. The imaging device 500 may be combined with a processor, such as a CPU, digital signal processor, or microprocessor, with or without memory storage on a single integrated circuit or on a different chip than the processor. In the example as shown in FIG. 6, the processing system 600 can generally comprise a central processing unit (CPU) 660, such as a microprocessor, that communicates with one or more input/output (I/O) devices 662 over a bus 664. The processing system 600 can also comprise random access memory (RAM) 666, and/or can include removable memory 668, such as flash memory, which can communicate with CPU 660 over the bus 664.

The processing system 600 can be any of various systems having digital circuits that could include the imaging device 500. Without being limiting, such a processing system 600 could include a computer system, a digital still or video camera illustrated by the dotted lines of FIG. 6, a scanner, a machine vision, a vehicle navigation, a video telephone system, a camera mobile telephone, a surveillance system, an auto focus system, a star tracker system, a motion detection system, an image stabilization system, and other systems supporting image acquisition. In the example shown in FIG. 6, the processing system 600 is employed in a digital still or video camera 600′, which has a camera body portion 670, a camera lens 672 for focusing an image on the pixel array 101, a view finder 674, and a shutter release button 676. When depressed, the shutter release button 676 operates the imaging device 500 so that light from an image passes through the camera lens 672. The incident light then impinges on and is captured by the pixel array 101 (see FIG. 5). As those skilled in the art will appreciate, the imaging device 500, the processing system 600, the camera system 600′ and other various components contained therein can also be formed and/or operate in various other ways.

It is again noted that although the above embodiments are described with reference to a CMOS imaging device, they are not limited to CMOS imaging devices and can be used with other solid state imaging device technology (e.g., CCD technology) as well.

While the foregoing description and drawings represent examples of embodiments, it will be understood that various additions, modifications, and substitutions may be made therein as defined in the accompanying claims. In particular, it will be clear to those skilled in the art that other specific forms, structures, arrangements, proportions, materials can be used without departing from the essential characteristics thereof. The presently disclosed embodiments are therefore to be considered in all respects as illustrative and not restrictive.

What is claimed as new and desired to be protected by Letters Patent of the United States is:

1. A microlens array comprising:
a plurality of curved microlenses formed over a substrate; and
a plurality of curved overlying portions formed over and conforming to the microlenses, the overlying portions providing the curved microlenses with increased uniformity in optical properties.

2. The microlens array of claim 1, wherein the overlying portions cause the combined height of the microlenses and the overlying portions to be substantially uniform across the microlens array.

3. The microlens array of claim 1, wherein the overlying portions are evenly distributed across the microlens array.

4. The microlens array of claim 1, wherein the overlying portions cause the curvature of the microlenses and the overlying portions to be substantially uniform across the microlens array.

5. The microlens array of claim 1, wherein the overlying portions each have a spherical upper surface with a radius smaller than a radius of the microlenses.

6. The microlens array of claim 1, wherein the overlying portions are integrated adjacent overlying portions.

7. The microlens array of claim 1, wherein the microlenses each have a spherical shape and the overlying portions at least partially overlap the spherical microlenses.

8. The microlens array of claim 1, wherein the microlenses and the overlying portions are formed of different materials.

9. The microlens array of claim 1, wherein at least some of the microlenses are formed to be at least partially in contact with each other.

10. The microlens array of claim 1, wherein at least some of the microlenses are formed to at least partially overlap with each other.

11. The microlens array of claim 1, wherein at least some of the microlenses are formed to at least partially abut each other.

12. The microlens array of claim 1, wherein at least some of the microlenses are formed to be substantially gapless.

13. The microlens array of claim 1, wherein the overlying portions each have a pin cushion shape.

14. A microlens array comprising:
a plurality of microlenses formed over a substrate; and
a plurality of continuous overlying portions formed over and conforming to the microlenses, the overlying portions having substantially uniform convex upper surfaces.

15. The microlens array of claim 14, wherein the overlying portions cause the combined height of the microlenses and the overlying portions to be substantially uniform across the microlens array.

16. The microlens array of claim 14, wherein the overlying portions are evenly distributed across the microlens array.

17. The microlens array of claim 14, wherein the overlying portions cause the curvature of the microlenses and the overlying portions to be substantially uniform across the microlens array.

18. The microlens array of claim 14, wherein the overlying portions have a spherical upper surface with a radius smaller than a radius of the microlenses.

19. The microlens array of claim 14, wherein the microlenses comprise first microlenses having a radius of curvature different from that of second microlenses.

20. The microlens array of claim 14, wherein the microlenses comprise first microlenses having a height different from that of second microlenses.

21. An imaging device comprising:
a plurality of photosensors formed in association with a substrate;
a microlens array formed over a substrate and having a plurality of microlenses; and
a plurality of curved overlying portions formed over the microlenses and causing the combined microlenses and overlying portions to be substantially uniform in optical properties.

22. The imaging device of claim 21, wherein the combined microlenses and overlying portions have substantially the same height across the microlens array.

23. The imaging device of claim 21, wherein the overlying portions are evenly distributed across the microlens array.

24. The imaging device of claim 21, wherein the combined microlenses and overlying portions have substantially the same curvature across the microlens array.

25. An imaging system comprising:
a plurality of photosensors formed in association with a substrate for capturing incident light from an image;
a microlens array formed over the photosensors and comprising:
a plurality of microlenses each aligned with one of the photosensors; and
a plurality of overlying portions formed over the microlenses and causing the combined microlenses and overlying portions to have substantially the same height; and
a processing circuit for reading out signals from the photosensors and processing the signals to obtain information of the image captured.

26. The imaging system of claim 25, wherein the overlying portions each comprise an upper surface having a substantially uniform curvature.

27. The imaging system of claim 25, wherein the overlying portions are evenly distributed across the microlens array.

28. The imaging system of claim 25, wherein the overlying portions are continuous and integrated overlying portions.

29. The imaging system of claim 25, wherein the imaging system is part of a camera and comprises a lens for focusing an image on the microlens array.

30. A method of forming a microlens array, the method comprising:
forming a plurality of microlenses over a substrate, at least some of the microlenses having a different shape from that of other microlenses; and
forming an overlying microlens material over the microlenses to cause the microlenses and overlying potions to have a substantially uniform shape.

31. The method of claim 30 further comprising patterning the overlying microlens material to form a plurality of overlying precursors over the microlenses.

32. The method of claim 31 further comprising shaping the overlying microlens precursors to form a plurality of overlying portions over and conforming to the microlenses.

33. The method of claim 32, wherein the step of shaping the overlying microlens precursors comprises forming the combined microlenses and overlying portions to have substantially the same height across the microlens array.

34. The method of claim 32, wherein the step of shaping the overlying microlens precursors comprises forming the overlying portions to be evenly distributed across the microlens array.

35. The method of claim 32, wherein the step of shaping the overlying microlens precursors comprises forming the combined microlenses and overlying portions to have substantially the same curvature across the microlens array.

36. The method of claim 30, wherein the step of shaping the overlying microlens precursors comprises reflowing the overlying microlens precursors.

37. The method of claim 30, wherein the step of forming a plurality of microlenses comprises forming a plurality of first microlenses before forming a plurality of second microlenses.

38. A method of forming an imaging device, the method comprising:
forming a plurality of photosensors in association with a substrate;
forming a microlens array over the substrate, the microlens array comprising a plurality of microlenses; and
forming a plurality of overlying portions over the microlens array to cause the combined microlenses and overlying portions to have a substantially uniform curvature across the microlens array.

39. The method of claim 38, wherein the step of forming a plurality of microlenses comprises forming a plurality of first microlenses before forming a plurality of second microlenses.
